(19) United States
(12) Patent Application Publication
(10) Pub. No.: US 2014/0314520 A1
(43) Pub. Date: Oct. 23, 2014

(54) Watercraft locking assembly

(71) Applicants: Matthew J. Friedman, Encinitas, CA (US); Michael L. Bill, Dana Point, CA (US)

(72) Inventors: Matthew J. Friedman, Encinitas, CA (US); Michael L. Bill, Dana Point, CA (US)

(21) Appl. No.: 14/259,564

(22) Filed: Apr. 23, 2014

Related U.S. Application Data
(60) Provisional application No. 61/815,131, filed on Apr. 23, 2013.

(51) Int. Cl. F16B 39/22

(52) U.S. Cl. CPC F16B 39/22
USPC 411/367

(57) ABSTRACT

A detachable fin is secured to a socket imbedded into the bottom layer of a watercraft such as a surfboard, wind surf board, standup paddle board, or kayak for example, by a mechanism including a screw whose head which is captured into a slot in the socket, and which passes through a hole in a spur projecting from the portion of the fin inserted into the slot. Two pivotally joined arms engaged over the screw astride a nut and forming a surrounding sleeve. The arms are locked in place by a padlock hasp, preventing the unauthorized extraction of the fin and a situs for locking to a cable or chain for securing the board.

### PRIOR APPLICATION

This application claims the benefit of U.S. Provisional Patent Application Ser. No. 61/815,131, filed 2013 Apr. 23, incorporated herein by reference.

### FIELD OF THE INVENTION

This invention relates to locking mechanisms, and more specifically to mechanisms for securing watercraft and their parts against theft.

### BACKGROUND

Surfboards have been widely available for many years, and more recently sailboards, paddle boards and related aquatic floatation devices have become increasingly popular. Surfboards exist in various sizes and shapes, for example, shortboards and longboards. Longboards are typically greater than 2.4 meters (8 feet) in length measured from nose to tail. In contrast, shortboards are typically less than 1.8 meters (6 feet) in length.

Watercraft surfaces are typically streamlined to avoid surfaces exhibiting high friction which can adversely impact the watercraft's ability to move swiftly through the water using as little energy as possible. In order to establish an appropriate buoyancy, repel water, and be relatively lightweight, durable and inexpensive to manufacture, many watercraft such as sailboards, paddle boards and surfboards are made of a foam core surrounding a stringer or other structural support, and covered with a relatively smooth and primarily uninterrupted fiberglass skin. This structure can also exhibit a relatively soft surface for comfort and safety reasons primarily.

Watercraft use many types of accessories which need to be mounted or secured to various parts of the craft and remain substantially streamlined. This can be particularly true of surfaces near the fin which are often attached to the undersurface of the rear of the board along an inset longitudinal channel. Further, surfboard and paddleboard fins can be made to be readily interchangeble for different styles of use or different water conditions. Therefore, it can be difficult to attach an accessory such as a fin to the typically smooth undersurface of a surfboard or paddleboard.

Surfboards, paddleboards, windsurfing boards and other types of light watercraft can be costly and are often the target of thieves. Even the detachable fins alone can be stolen. In the past boards have been protectively secured to an automobile roof rack or to the bed of a pickup truck in order to prevent theft. However detachable fins on these devices are often less protected.

Accordingly there is a need for a convenient and inexpensive way to lock such a fin onto a watercraft and prevent theft of the fin and board.

The invention results from an attempt to address one or more of the above identified difficulties.

### SUMMARY

The principal and secondary objects of the invention are to provide an improved water craft mechanism for securing it from acts of theft. These and other objects are achieved by an assembly for locking a nut to a fastening post.

In some embodiments there is provided a rapid and convenient means for locking a removable fin onto a watercraft.

In some embodiments there is provided a rapid and convenient means for providing a locking situs onto a watercraft.

The original text of the original claims is incorporated herein by reference as describing features in some embodiments.

In some embodiments there is provided a securable screw-and-nut assembly which comprises: a screw; a nut engaged over said screw; first and second arms, each having a proximal end and a distal end; the proximal end of said first arm having an aperture engaged over said screw; a sleeve engaged over said screw and around said nut; said proximal ends being positioned astride said sleeve; and said arms having aligned holes sized to be engaged by a locking device.

In some embodiments said sleeve is integrally connected to said first arm.

In some embodiments the proximal end of said second arm forms a cap of said sleeve.

In some embodiments said cap comprises a diametrically widened collar overlapping said proximal end of said first arm.

In some embodiments the proximal end of said second arm has a substantially central aperture engaged over said screw.

In some embodiments there is provided a securable screw-and-nut assembly which further comprises a pin pivotally connecting said distal ends about an axis normal to said screw.

In some embodiments there is provided a securable screw-and-nut assembly which further comprises: said screw comprising: a threaded shaft; and, a head at one extremity of said post; said head having and outer peripheral dimension larger than a diameter of said shaft.

In some embodiments said head has a polygonal periphery.

In some embodiments there is provided a securable screw-and-nut assembly which further comprises: a first member having a slot; a second member having a portion inserted into said slot and an aperture dimensioned to receive said screw; and wherein said slot has an enlarged internal dimensioned to slidingly hold said head.

In some embodiments said first member comprises a oblong socket; and said second member comprise a spur projecting rearwardly from said portion.

In some embodiments said socket comprises: an elongated trough; a shallow, peripheral flange; said socket being dimensioned for insertion into the bottom surface of a watercraft.

In some embodiments said locking device comprises a padlock hasp.

In some embodiments said second member comprises a detachable fin; and said watercraft comprises a standup paddle board.

In some embodiments there is provided an ornamental design for a nut securing assembly for watercraft as shown in the drawing.

### BRIEF DESCRIPTION OF THE DRAWING

FIG. 1 is a perspective view of a locking assembly in the unlocked position according to an exemplary embodiment of the invention.

FIG. 2 is a perspective view thereof in the locked position.

FIG. 3 is a diagrammatic cross-sectional view of a locking assembly in the unlocked position according to an exemplary embodiment of the invention.

FIG. 4 is a diagrammatic cross-sectional view thereof in the locked position.

FIG. 5 is an exploded side view of a watercraft fin and its locking mechanism.

FIG. 6 is bottom view of a fin socket.

FIG. 7 is a cross-sectional view taken along line 7-7 of FIG. 6.

### DESCRIPTION OF THE PREFERRED EMBODIMENTS

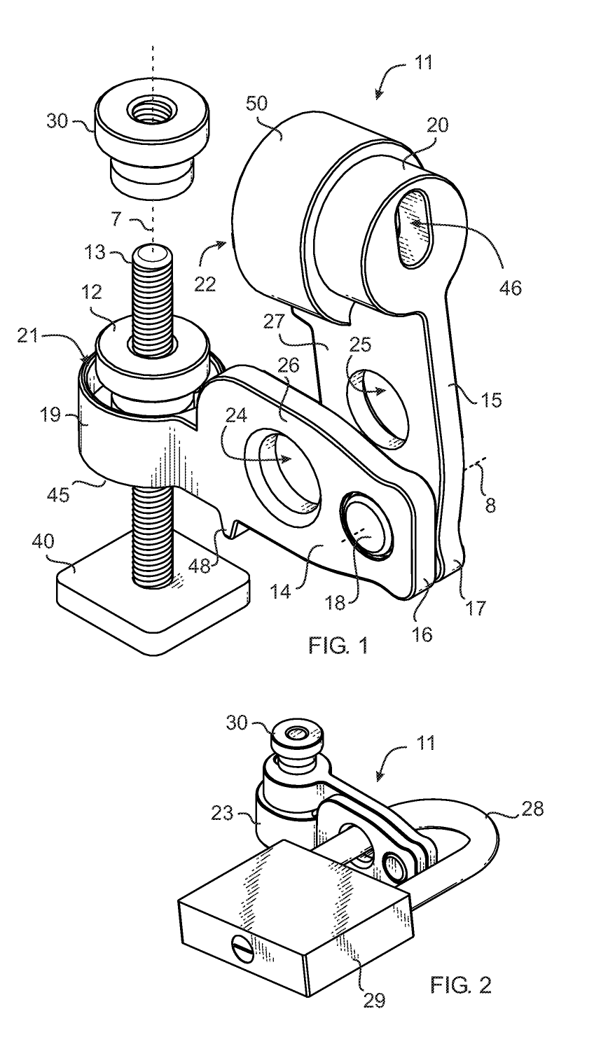

Referring now to the drawing, there is shown in FIGS. 1-4 a securable fastener-and-nut assembly 11 designed to prevent a nut 12 from being accessed and unscrewed while it is mounted on a screw 13. While engaged the assembly provides a situs for engagement by a hasped lock 29 for further securing the entire board from theft.

The assembly comprises a pair of arms 14, 15. The arms are pivotally connected at their distal ends 16, 17 by a pin or rivet 18 having a rotation axis 8 normal to the threading axis 7 of the screw 13. The arms feature at their proximal ends 19, 20 a pair of cups 21, 22 facing and axially aligned with each other so as to form, when brought together a substantially cylindrical sleeve 23 shaped and dimensioned to loosely enclose the nut 12 which has been engaged on the screw 13 and through apertures 45, 46 in the center of each cup. An oversize encapsulating collar 50 protects the gap between the top and bottom cups. The upper aperture 46 can be made oblong to allow it to swing over the end 47 of the screw while the bottom cup arm 14 is secured to the screw. Similarly, the bottom opening of the upper cup can be made oblong to allow it to swing over the substantially circular top opening of the bottom cup.

Matching holes 24, 25 in the median portions 26, 27 of the arms are sized and located to be engaged by the hasp 28 of a padlock 29. An optional capping nut 30 may be used to secure the assembly in certain applications and to protect the end of the screw and things it may contact from damage or injury. An anchor nib 48 extends downwardly from the bottom cup arm 14 to prevent angular movement of the secured arms about the screw by engaging a bearing surface on the undersurface of the board. An optional second anchor nib 49 can extend similarly from the top cup arm 15 in order to strengthen the resistance to angular movement. Such a bearing surface can be formed, for example, by a spur 43 on the root 36 of fin 37 as described below.

Accordingly, once the arms 14,15 have been brought together astride the nut 12, and the device is padlocked, it becomes impossible to get access to the nut and unscrew it. Further, the combination of the assembly with the board forms on the board a situs for engaging a locking device such as a padlock to the board. Further, the device can be adjusted angularly with respect to the screw so that the arms are oriented to have their major dimensions substantially in line with the fin. In other words, the arms can be oriented to the direction of flowing water when the board is in use thereby reducing drag.

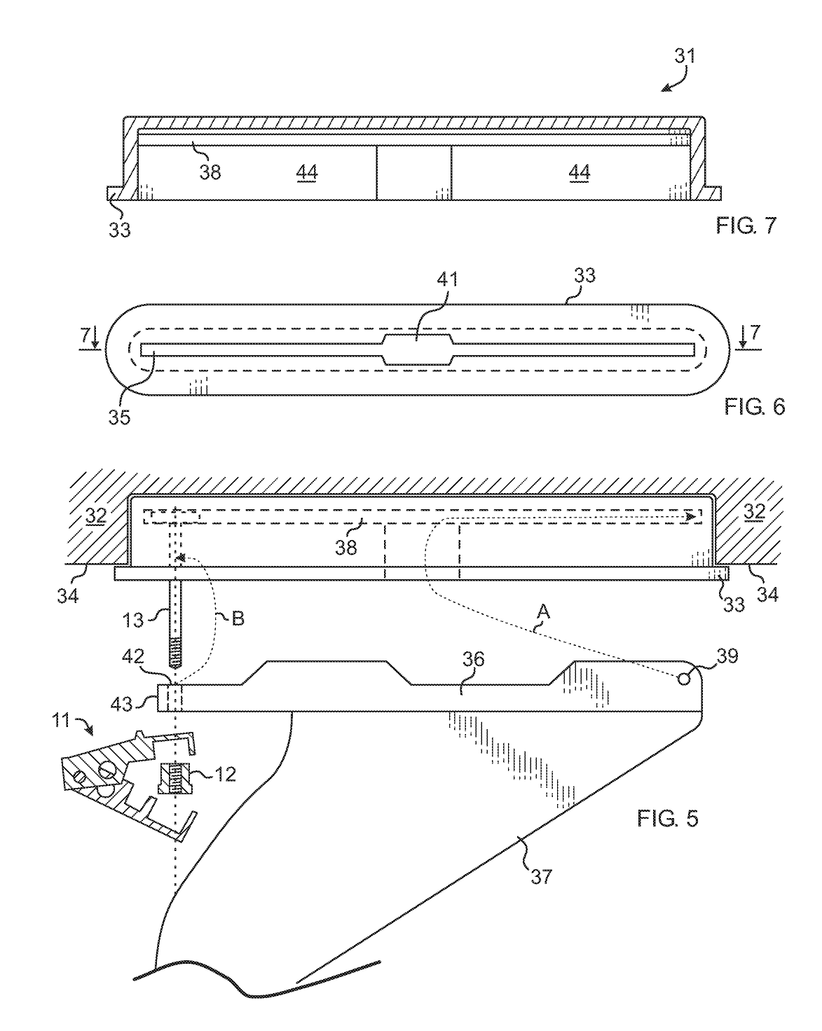

Referring now to FIGS. 5-7, there is shown an oblong fin socket 31 imbedded into the bottom layer 32 of a watercraft such as a standup paddle board. The socket is surrounded at its base by a flange 33 that rests against the bottom surface 34 of the craft. A longitudinal slot 35 in the middle of the socket is shaped and dimensioned to form a trough for nesting the root 36 of a fin 37. The slot has a widened lateral channel forming an enlarged internal dimension 38 into which a pair of coaxial cylindrical lateral posts 39 projecting laterally from both sides of one end of the root, as well as the head 40 of the screw 13 can be retained after having been inserted into the slot through an enlarged portion 41 as illustrated by the arrow A. Once the posts are moved to one end of the slot, and the head of the screw to the opposite end, the shaft of the screw is threaded through a bore 42 drilled in a spur 43 projecting rearwardly from the root of the fin. That part of the root is pushed into the slot as indicated by arrow B. The locking assembly, nut and padlock can then be installed to secure the fin into its socket. A chain or cable can be secured to the padlock as well, thereby securing the board to some structure such as a bicycle rack or bracket in the bed of a pickup truck for example.

The head of the screw 40 must have a cross-diameter larger than both: the cross-diameter of the threaded shaft of the screw; and, the width of the non-enlarged portions 44 of the slot, and preferably have a polygonal shape such as a square as illustrated in FIG. 1 which will inhibit rotation of the head and thus the screw when engaged in the lateral channel of the trough.

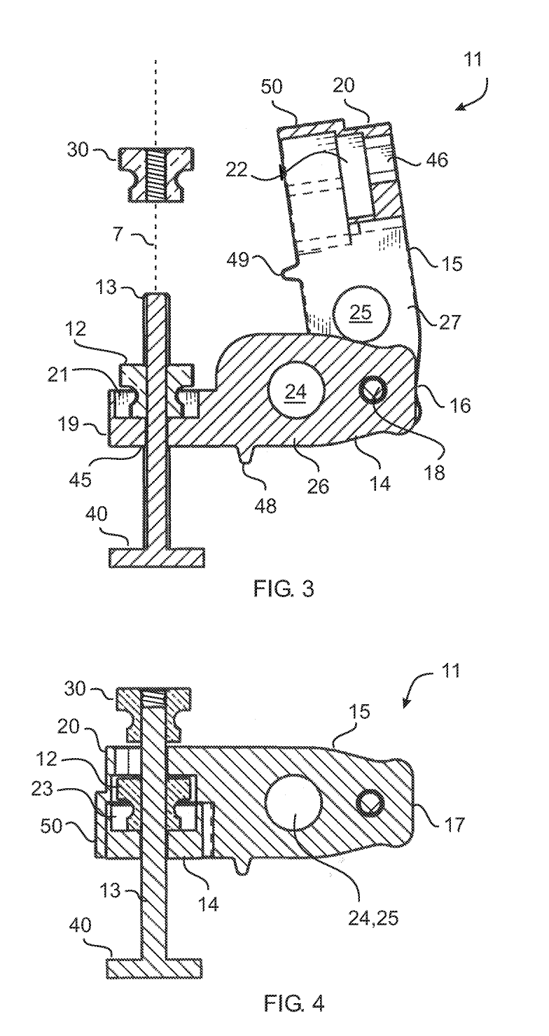

Referring now to FIGS. 1 and 3 there is shown an ornamental design for a nut securing assembly for watercraft. FIG. 1 shows a back, left side, top view of a nut securing assembly in an open configuration showing an embodiment of my design. FIG. 3 shows a cross-sectional left side view of a nut securing assembly in an open configuration showing an embodiment of my design.

While the preferred embodiment of the invention has been disclosed, modifications may be made and other embodiment may be devised without departing from the spirit of the invention and the scope of the appended claims.

1. A securable screw-and-nut assembly which comprises:
a screw;
a nut engaged over said screw;
first and second arms, each having a proximal end and a distal end;
the proximal end of said first arm having an aperture engaged over said screw;
a sleeve engaged over said screw and around said nut;
said proximal ends being positioned astride said sleeve; and
said arms having aligned holes sized to be engaged by a locking device.

2. The assembly of claim 1, wherein said sleeve is integrally connected to said first arm.

3. The assembly of claim 1, wherein the proximal end of said second arm forms a cap of said sleeve.

4. The assembly of claim 3, wherein said cap comprises a diametrically widened collar overlapping said proximal end of said first arm.

5. The assembly of claim 3, wherein the proximal end of said second arm has a substantially central aperture engaged over said screw.

6. The assembly of claim 1, which further comprises a pin pivotally connecting said distal ends about an axis normal to said screw.

7. The assembly of claim 1, which further comprises:
said screw comprising:
a threaded shaft; and,
a head at one extremity of said post;
said head having and outer peripheral dimension larger than a diameter of said shaft.

8. The assembly of claim 7, wherein said head has a polygonal periphery.

9. A locking mechanism which comprises:
the assembly of claim 7;
a first member having a slot;
a second member having a portion inserted into said slot and an aperture dimensioned to receive said screw; and wherein said slot has an enlarged internal dimensioned to slidingly hold said head.

10. The mechanism of claim 9, wherein said first member comprises a oblong socket; and said second member comprise a spur projecting rearwardly from said portion.

11. The mechanism of claim 10, wherein said socket comprises:
an elongated trough;
a shallow, peripheral flange;
said socket being dimensioned for insertion into the bottom surface of a watercraft.

12. The mechanism of claim 11, wherein said locking device comprises a padlock hasp.

13. The mechanism of claim 11, wherein said second member comprises a detachable fin; and said watercraft comprises a standup paddle board.

14. An ornamental design for a nut securing assembly for watercraft as shown in the drawing.
